(19) United States
(12) Patent Application Publication
(10) Pub. No.: US 2014/0000137 A1
(43) Pub. Date: Jan. 2, 2014

(54) HUNTER SAFETY SYSTEM

(71) Applicant: Donald E. Gray, JR., Virginia Beach, VA (US)

(72) Inventor: Donald E. Gray, JR., Virginia Beach, VA (US)

(21) Appl. No.: 13/933,533

(22) Filed: Jul. 2, 2013

Related U.S. Application Data
(60) Provisional application No. 61/690,619, filed on Jul. 2, 2012.

(51) Int. Cl. A01M 31/00

(52) U.S. Cl. CPC A01M 31/00
USPC 40/617

(57) ABSTRACT

A hunter safety system includes a plurality of highly visible signs that are deployed outward from a hunting spot. The signs include indicia which alerts others to the presence of a hunter to prevent them from shooting at the hunter and inform them of the location of the hunter. In this manner, others may position themselves on the backside of tree to avoid being inadvertently shot by the hunter who isn't aware of their location. The signs preferably include bright colors to contrast them from the foliage.

The present application relates to U.S. Provisional Patent Application Ser. No. 61/690,619 filed on Jul. 2, 2012 and claims priority therefrom.

The present application was not subject to federal research and/or development funding.

### TECHNICAL FIELD

Generally, the invention relates to a hunter safety system for alerting others to the presence of other hunters and preventing hunters from being inadvertently shot. More specifically, the invention relates to a hunter safety limb hanging sign system comprising a plurality of warning signs that are displayed about the hunter's location or hunting blind and which informs others of the hunter's location to prevent them from shooting at him.

### BACKGROUND OF THE INVENTION

On rare occasions, shooting accidents occur during hunting trips. Typical causes are improper identification of game, improper handling of firearms, and failure to recognize the location of another hunter in thick woods. Most of these causes can be alleviated through proper training of the hunter. However, it is sometimes difficult to identify the location of another hunter in thick forest settings. It is an aim of the present invention to assist hunters in identifying the location of other hunters.

Hunters have previously identified trails to a hunting blind or spot by marking with brightly colored ribbons or reflective tacks. For example, U.S. Pat. Pub. No. 2010/0154263 discloses a hunter safety apparatus that includes a hunter safety sign and reflective pins. The sign includes a base plate and a storage area for reflective pins. This base plate is rigid and contributes to a heavier load for the hunter using it.

### SUMMARY OF THE INVENTION

The instant invention is a hunter safety limb hanging sign system which designates a hunter's perimeter and indicates to others that a hunter is in the area. This informs other hunters of the general location of the hunter. Signs are in placard form and include a curved aperture having an upper region that rests on a tree limb. The signs are deployed by the hunter as he enters the hunting area and can be easily removed upon completion of the hunt. The signs secure an area from other hunters entering or discharging their firearms toward the area. The signs comprise a material that is reusable and durable.

In the preferred embodiment, each sign includes a body which is rectangular in shape substantially 5″ in width and 11 ⅝″ in length with a thickness of substantially 0.030″. The top of each sign includes a necked-down portion having a central opening and connected to the bottom portion. The bottom portion is substantially 5″ in width while the upper portion is substantially 3 ¼″ in width. A 1/16″ slit extends from an edge of the top portion into the central opening to allow the signs to be hung from a tree branch or other bushy plant. The central opening has a preferable diameter of substantially 1 ¼″ and is substantially centered within the top portion of the sign. The overall height of the top portion is substantially 2 ⅝″. The slit begins on the upper portion substantially 15/16″ above the top of the shoulder and substantially 1 ⅝″ below a rounded upper corner of the top portion. The bottom portion is substantially 8 in height. A shoulder portion extends on opposite sides of the sign and has a preferably height of substantially ½″. The upper portion of the sign includes a curved opening that receives a portion of a tree limb or branch to securely mount the sign remote from the hunter's blind. Typical materials for the sign include waterproof materials such as plastic and are brightly colored. For example, the signs may be colored as blaze orange, neon green, yellow, pink or any other bright color easily recognizable by another hunter. The size and shapes of the signs may be modified. The preferred size and shape is large enough to alert others of the presence of the user while still being small enough and lightweight such that the signs are easily carried by the users.

The signs are deployed as a hunter enters the desired hunting area. Typically, the hunter places the signs hundred yards or more in a circular pattern about the hunting blind or area where the hunter is watching for game to create and maintain a safe perimeter. The signs are collected by the hunter at the conclusion of the hunting day for redeployment in another area or at another time.

It is an object of the invention to provide a hunter safety signage system that prevents hunting accidents by informing others of the presence of a hunter in a specific location.

It is a further object of the invention to assist hunters in providing a safer hunting environment.

Additional objects and advantages of the invention will be set forth in part in the description which follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1 shows a hunter safety system comprising a plurality of signs deployed on and around a hunting blind.

FIG. 2 shows a first embodiment of a sign used in the invention with indicia indicating that the sign may be utilized as a trail marker.

FIG. 3 shows the first embodiment of a sign with indicia indicating the presence of a hunter.

FIG. 4 shows the first embodiment with additional indicia thereon.

FIG. 5 shows the various parts of first embodiment of the sign without indicia thereon.

FIG. 6 shows a second embodiment of the sign without indicia.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

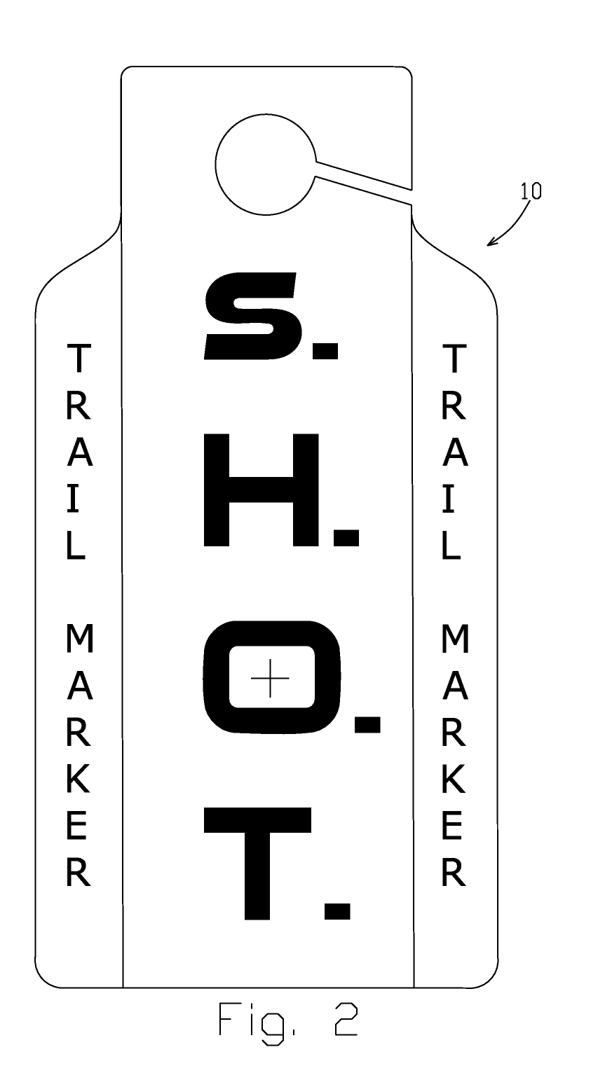

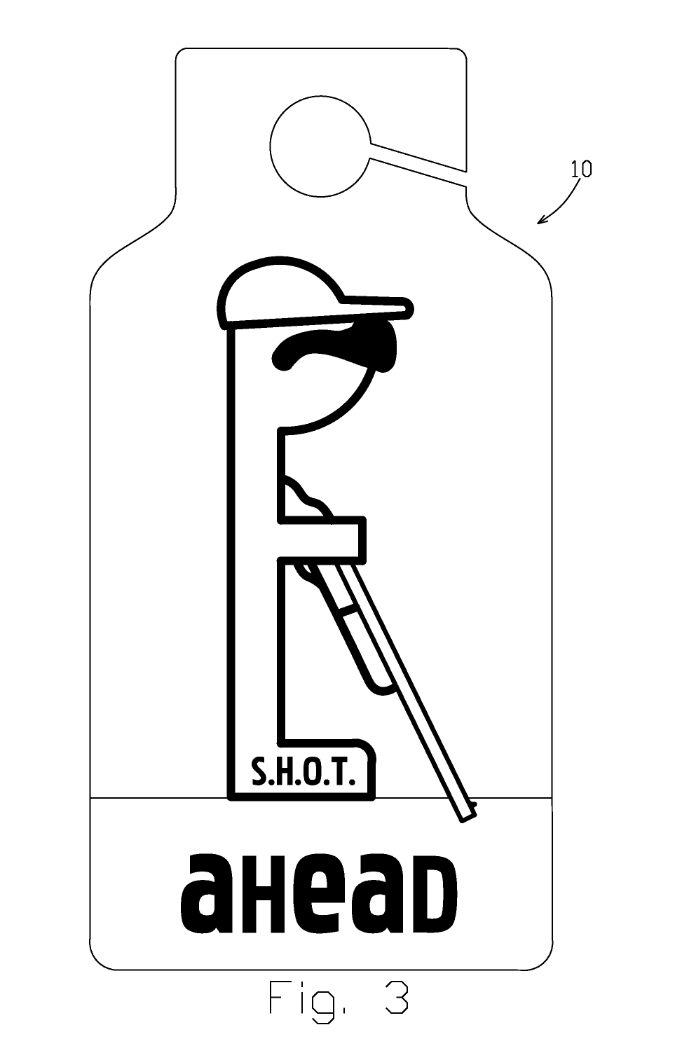

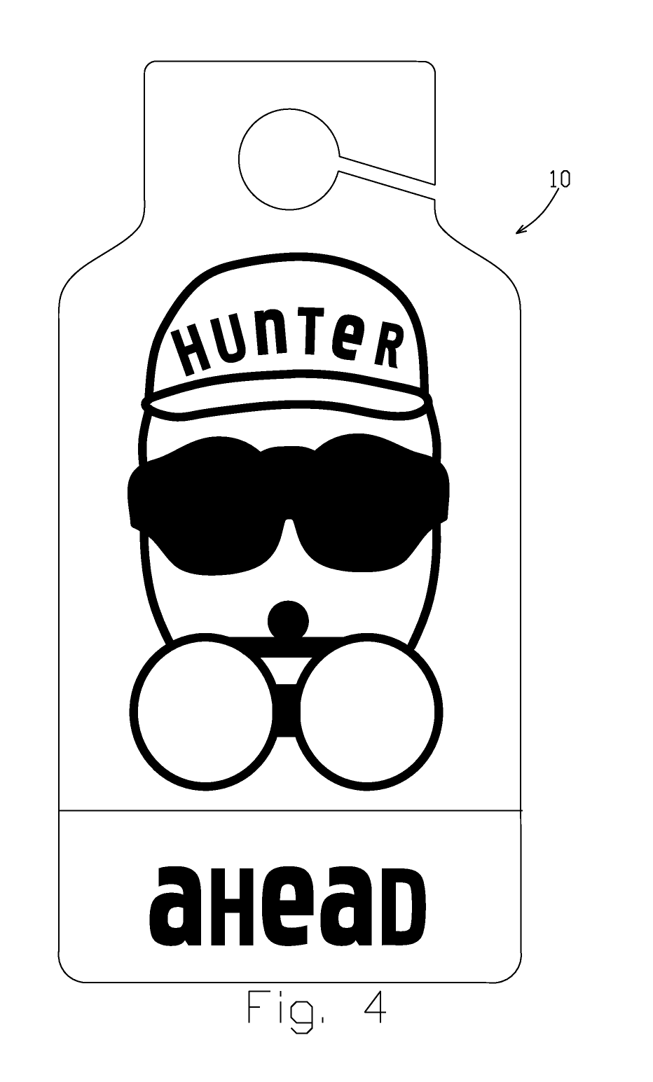

FIGS. 2-6 show various embodiments of the invention. As can be recognized, each sign is brightly colored and may include a logo, picture, or other indicia indicating that a hunter is located nearby. Each sign may be equipped with a front side message indicating that a hunter is hunting behind the sign. A backside of each sign may include a message that the sign indicates a perimeter of a hunter and that care should be taken when hunting near the perimeter of the hunter. A plurality of signs is arranged on limbs of trees outlying from a hunting area of the user. In the preferred use, the signs are provided in a radiating manner outward according to the type of hunting and the various firearms being used in the hunt. For instance, if handguns are being used, the signs may be deployed at a range of 50-100 meters from the hunter. If shotguns are being used, the signs may be deployed at a longer distance than for handgun use. If rifles are being used, the signs may be deployed from 100-200 meters from the user. In this manner, the signs push back the hunting area by alerting others at greater distance from the hunter.

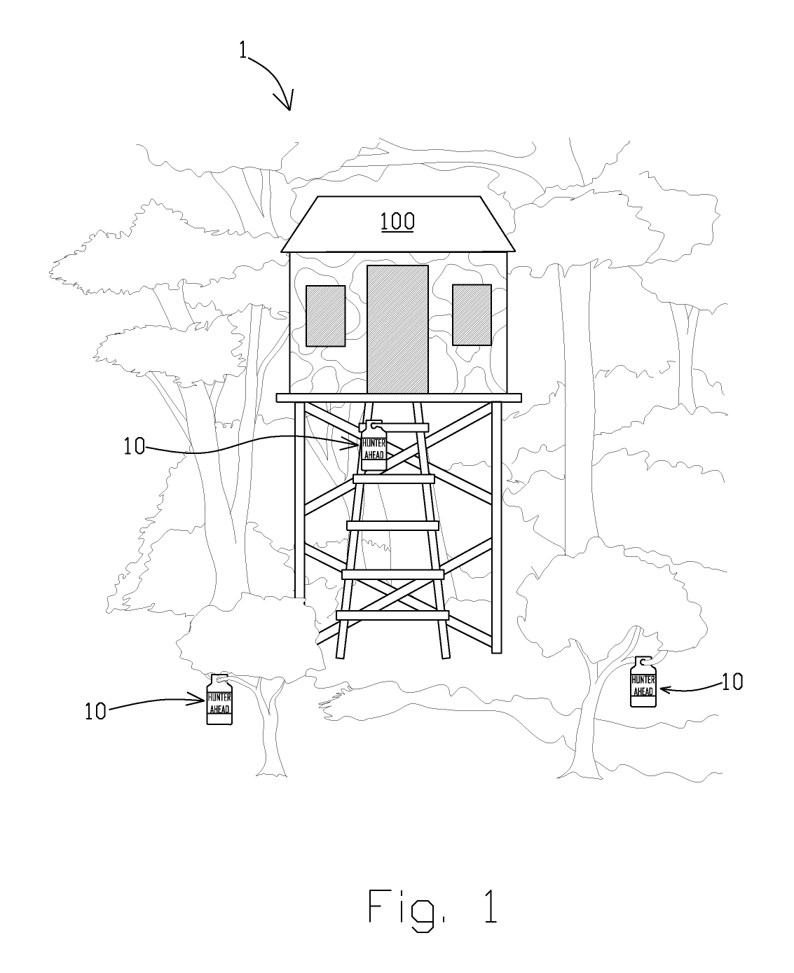

FIG. 1 shows a safety hanging on trees system 1. The system includes a plurality of signs 10 deployed on the steps of the hunting blind 100 and on bushes remote from the blind. In this instance, signs 10 indicate the presence of a hunter within the hunting blind 100. Thus, anyone approaching the hunting blind is quickly alerted to the presence of the hunter within the blind. The shape of the sign is substantially rectangular with an upper region that includes a necked-down portion at the top formed from opposing shoulders. A slit extends from one side of the upper region into a substantially circular opening. In this manner, the sign may be slipped across a limb of a tree and displayed thereon during a hunt. After, the hunter easily removes the signs by simply pulling them from the limb.

FIGS. 2-4 shows a first embodiment of the sign 10 with various indicia displayed thereon. When deployed each indicates the presence of a hunter in a particular hunting area. As can be understood, the hunter simply walks in a substantially circular path away from his or her hunting spot. As previously discussed, the location of the signs may be extended according to the hunting season or type of firearm being used in that region. Various high visibility bright colors are used to alert others of the presence of the hunter.

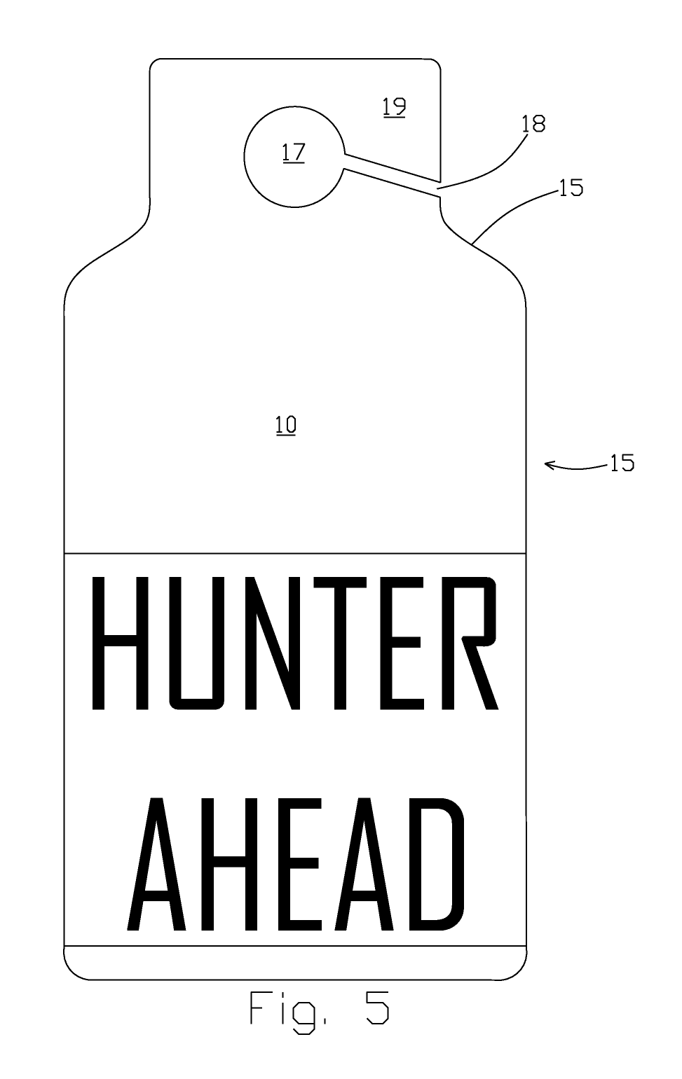

FIG. 5 shows a first embodiment of the sign 10 for use in the hunter safety system 1. In this embodiment, the sign 1 includes an upper portion 19 having a slit 18 that extends from a side above the shoulder 16 into into the central opening 17. The bottom portion 15 is longer that the upper portion as shown. The preferable dimensions are set forth above.

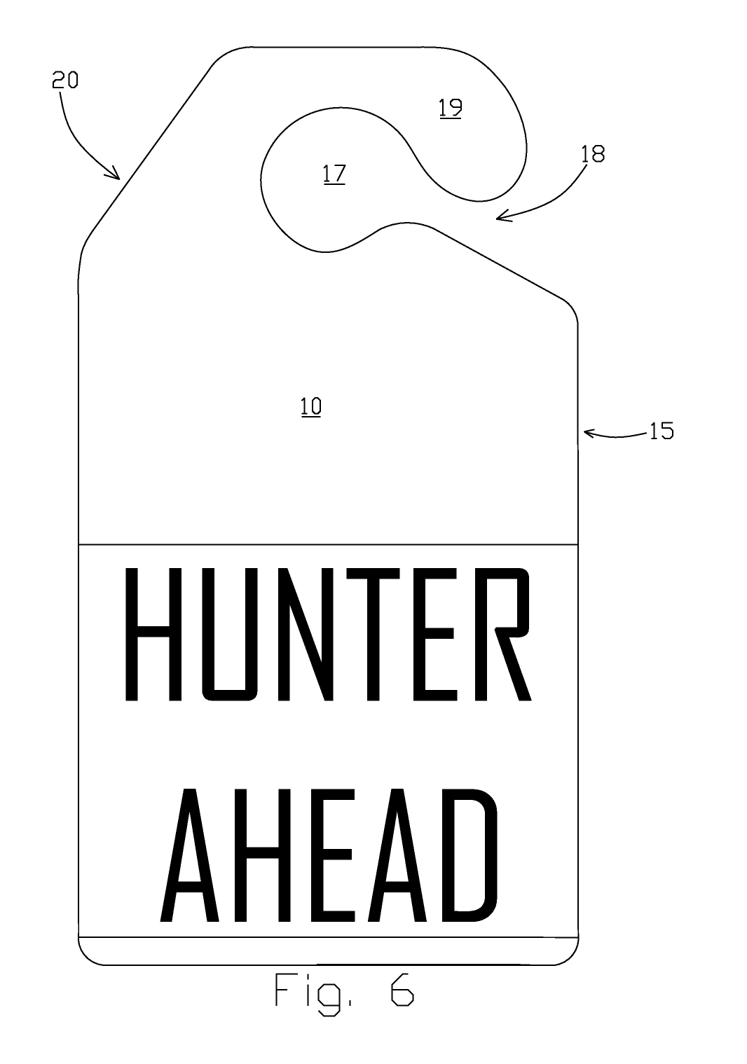

FIG. 6 shows a second shape of the signs. A rounded hook is created at the upper portion 19 of the sign 10 by removing a larger a portion of the slit 18 as shown. The central opening 17 may be larger in this embodiment than in the previous embodiment. This shape is useful in areas of mature timber which tend to have larger limbs. It should be noted that in areas of with very mature or virgin timber, a string may be passed about the trunk of a large tree to pinch the sign against the tree bark.

It is to be understood that the invention is not limited to the exact construction illustrated and described above, but that various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A hunter safety system comprising:
a plurality of high visibility signs deployed about a location of a hunter, each sign comprising a front side, a back side and a body having a top portion which includes a central opening and being connected to the bottom portion, a slit extends from an edge of the top portion into the central opening to allow each sign to be hung from a tree, a shoulder extending between the bottom portion and the bottom portion on opposite sides thereof, indicia arranged on at least the front side indicating that the hunter is located behind the plurality of high visibility signs .

2. The hunter safety system of claim 1 wherein each sign of the plurality of high visibility signs includes a bottom portion that is 5″ in width and an overall length of each sign of 11 ⅝″ with a thickness of substantially 0.030″.

3. The hunter safety system of claim 1 wherein the top portion is substantially 3 ¼″ in width and having a 1/16″ slit extending from an edge of the top portion into the central opening to allow the signs to be hung.

4. The hunter safety system of claim 1 wherein the central opening has a preferable diameter of substantially 1 ¼″ and is substantially centered within the top portion of the sign and wherein the overall height of the top portion is substantially 2 ⅝″.

5. The hunter safety system of claim 1 wherein the slit is formed in the portion substantially 15/16″ above the shoulder and substantially 1 ⅝″ below a rounded upper corner of the top portion and the bottom portion is substantially 8 in height.

6. The hunter safety system of claim 1 wherein each shoulder has a height of substantially ½″.

7. A hunter safety system comprising:
a plurality of high visibility signs deployed about a location of a hunter, each sign comprising a front side, a back side and a body having a top portion which includes a central opening and being connected to the bottom portion, a slit extends from an edge of the top portion into the central opening to allow each sign to be hung from a tree, a shoulder extending between the bottom portion and the bottom portion on opposite sides thereof, indicia arranged on at least the front side indicating that the hunter is located behind the plurality of high visibility signs;
wherein each sign of the plurality of high visibility signs includes a bottom portion that is 5″ in width and an overall length of each sign of 11 ⅝″ with a thickness of substantially 0.030″, wherein the top portion is substantially 3 ¼″ in width and having a 1/16″ slit extending from an edge of the top portion into the central opening to allow the signs to be hung,
wherein the central opening has a preferable diameter of substantially 1 ¼″ and is substantially centered within the top portion of the sign and wherein the overall height of the top portion is substantially 2 ⅝″,
wherein the slit is formed in the portion substantially 15/16″ above the shoulder and substantially 1 ⅝″ below a rounded upper corner of the top portion and the bottom portion is substantially 8 in height, and
wherein each shoulder has a preferably height of substantially ½″.
